(19) United States
(12) Patent Application Publication
(10) Pub. No.: US 2004/0211122 A1
(43) Pub. Date: Oct. 28, 2004

(54) Cable window lifter for a motor vehicle door comprising at least one pivotable guiding rail

(76) Inventors: Jan Freymuth, Sitges (ES); Manfred Frei, Barcelona (ES)

Correspondence Address: CHRISTIE, PARKER & HALE, LLP, PO BOX 7068, PASADENA, CA, 91109-7068, US

(21) Appl. No.: 10/478,241

(22) PCT Filed: May 16, 2002
(86) PCT No.: PCT/DE02/01809

(30) Foreign Application Priority Data
May 22, 2001 (DE) 101 24 884.9

(51) Int. Cl. B60J 5/04

(52) U.S. Cl. 49/502

(57) ABSTRACT

A motor vehicle door has a removable door outer skin, a module carrier, a door inner skin and a door inner trim. The door inner skin is connected on one side to the removable door outer skin and on the other side to the module carrier. A door inner trim is fixed on a side of the module carrier facing a vehicle interior and at least one guide rail of a cable window lifter is prefitted on the other side of the module carrier. In one of an upper and lower region of the guide rail, a pivotal bearing is provided with a pivotal axis running substantially horizontal and parallel to the door plane for the purpose of prefitting the guide rail on the module carrier. Proximate to the other of the upper and lower regions of the guide rail, a stop face is provided that is associated with a side of the door inner skin which faces the door outer skin.

### CROSS REFERENCE TO RELATED APPLICATION(S)

This application is a National Phase Patent Application of International Application Number PCT/DE02/01809, filed on May 16, 2002, which claims priority of German Patent Application Number 101 24 884.9, filed on May 22, 2001.

### FIELD

The invention relates to a motor vehicle door with a removable door outer skin and with a door body whose door inner skin has an opening which can be closed by a module carrier. The invention can be used with particular advantage if the guide rail of a cable window lifter on one side and a door inner trim on the other side are prefitted on the module carrier.

### BACKGROUND

From DE 200 09 435 U1 a motor vehicle door is known having a box-like door body which is formed from a door inner skin wherein the base surface of the door inner skin has an assembly opening which can be closed by a support module connected to a window lifter. After finishing the assembly work inside the door body the door body is completed by connecting the door outer skin and door inner skin and by fixing on the door inside trim.

The drawback here however is that the components which are associated with the door inside trim—such as for example electrical switches, speakers or electronic control device —cannot be combined with the components associated with the hollow space of the door—e.g. an electrically operated window lifter or lock—into one highly integrated function module. This would have the advantage however that one complete system could be pre-checked so that any possible faults which may appear when the individual components interact would become apparent before the vehicle door is assembled.

A module carrier with a very high degree of integration is described in DE 195 09 282 A1. Practically all the function components of the door, more particularly the window lifter mechanism with drive unit, lock, electronic controls with switches, internal opener with force transfer elements, speakers and wiring harness, are pre-fitted on the two sides of the base plate. Furthermore at least one part of the door inside trim is likewise a constituent part of the module. In order to ensure that the module is fixed on the door body fixing points are provided along the edge of the base plate which are then covered by clip-on frame elements.

The drawback with this proposal is however the need for providing additional design elements to cover the fixing points. Furthermore the window panes which are becoming larger and larger compared with the door height are placing increasingly higher demands on the lifting height to be provided by the window lifter; i.e. the guide rails of a cable window lifter are often much longer than the corresponding height of the cut-out section provided in the door inner skin which is to be covered by the module carrier. From these contradicting demands there are design limitations when ensuring that it is still possible to fit the system.

The object of the invention is therefore to provide a vehicle door of the type mentioned at the beginning which permits the formation of a highly integrated function module with a door inner trim mounted on a support plate as well as also a comparatively large lifting height of the window pane whilst at the same time is simple to fit.

### SUMMARY

According to one embodiment of the invention, the upper or lower fixing region of the guide rail which serves for prefitting on the module carrier is formed as a pivotal bearing whereby the pivotal axis runs substantially horizontal and parallel to the door plane. Before fitting the module carrier on the assembly opening of the door inner skin the guide rail of the cable window lifter is swivelled transversely to the door plane until it can pass the assembly opening. Depending on which structural conditions are provided regarding the interfaces between the door body and module system the mounting of the upper edge of the door inside trim in the window ledge in the region of the shaft opening is possible at the same time or only after fitting the module carrier; then the door outer skin can be fixed on the door inner skin through the other fixing area of the guide rail, which is associated with a stop face on the side of the door inner skin facing the door outer skin. Both the fixing elements for the module carrier and for the guide rail are thereby actuated from the wet space side, i.e. through the opening which is not covered by the removable outer skin panel.

It is hereby possible to provide for completing the door body a highly integrated module system which can comprise all the mechanical and electrical components which can be fitted on the wet space side and the dry space side of the module carrier, including the door inner trim. Furthermore comparatively long guide rails for cable window lifters can be used which can otherwise only be fitted separately in the door body, because when prefitting on a module carrier collisions with other door components would be unavoidable or the mounting of the door inner trim in the ledge area would not be possible.

According to a preferred variation of the invention the parts of the pivotal bearing on the module carrier side are integral constituent parts of a module carrier made from plastics whereby narrow tolerances can be ensured and additional handling and assembly costs are unnecessary. The said advantages can also be achieved as regards the parts of the pivotal bearing on the guide rail side, if these are designed as integral constituent parts of a guide rail made from plastics or a cable guide made from plastics and connectable with the guide rail. With a sufficiently stable design of the pivotal bearing the pivotal bearing can also undertake the function of a conventional fixing point where the connection with the module carrier is produced through screws or rivets, thereby further reducing the assembly costs.

Naturally it is also possible within the scope of the invention to make the parts of the pivotal bearing on the module carrier side as a separate unit and then to connect same to the module carrier. This can be advantageous if the plastics module carrier for avoiding expensive injection moulding tools is to have only very simple contours (the same applies for a module carrier made by metal casting processes) or if the module carrier is to be made from a sheet metal plate.

A particularly simple assembly is ensured through a pivotal bearing which on the one hand (e.g. on the module carrier) forms a bearing bush region which as regards the pivotal axis has a radially directed opening with a reduced width compared to the bearing bush diameter. A bearing bolt having opposing flattened sides and associated for example with the guide rail is inserted through this opening so that the bearing bolt is narrower in this area and deviates from the cylindrical bearing contour. The width of the bearing bolt between these flattened sides is thereby the width of the radially aligned opening of the bearing bush.

The radially aligned opening of the bearing bush preferably points upwards. The flattened sides of the bearing bolt are arranged in relation to the guide rail so that these run transversely, preferably orthogonal to the alignment of the opening when the guide rail is located in its useful position so that the guide rail is secured in the pivotal bearing. The guide rail can thus only be fitted and dismantled at an angle to the module carrier.

The pivotal bearing can form the end of a cable guide connected to the guide rail or the end of the guide rail itself. If however the side of the cable guide and the pivotal bearing cannot coincide then it is also possible that the pivotal bearing is arranged spaced from the upper edge of the cable guide or the guide rail. In this case a sufficient clearance is to be provided in the module carrier so that when swivelling the guide rail about the angular region which is required for fitting the modular system the end of the guide rail on the pivotal bearing side or the corresponding cable guide does not strike against the module carrier. For this a corresponding bulge is provided in the wall of the module carrier (if a wet/dry space separation is provided in the door).

According to a further embodiment of the invention the pivotal bearing serves mainly for prefitting the guide rail on the module carrier; the adjusting forces of the window pane are taken up by a separate fixing element which fixes the guide rail on the door inner skin. Preferably the fixing axis of the fixing site of the guide rail runs through the cable guide; in the event of using a cable guide pulley its rotary axis is to be identical with the fixing axis.

By means of a so-called transport securing device which holds the swivel guide rail in a defined position prior to fitting the module carrier it can be ensured that when handling the module system the guide rails do not carry out any uncontrolled movements. A transport securing device of this kind should preferably be provided at a distance from the pivotal bearing, preferably in the region of the other cable guide, and can be designed for example in the form a clip-on connection.

### BRIEF DESCRIPTION OF THE DRAWINGS

The invention will now be explained in further detail with reference to the embodiments illustrated in the accompanying drawings.

They Show:

FIG. 1 a side cross-sectional view through a motor vehicle door with one embodiment of a pivotal guide rail prior to its fitting in the region of the lower cable guide;

FIG. 2a a front perspective view of another embodiment of a pivotal bearing on a cut-out section of a module carrier in which the guide rail of the window lifter is located in the assembly position;

FIG. 2b a side perspective view of the pivotal bearing according to FIG. 2a;

FIG. 3a a front perspective view of the pivotal bearing according to FIG. 2a in which the guide rail of the window lifter is located in the position of use;

FIG. 3b a side perspective view of the pivotal bearing according to FIG. 3a;

FIG. 4 a plan perspective view of the door body from the side of the door outer skin with a module carrier covering a large surface cut-out section in the door inner skin, with the window lifter guide rails held in the upper cable guide area through a pivotal bearing on the module carrier;

FIG. 5a a side cross-sectional view of the upper region of another embodiment of a module system with a pivotal bearing spaced from the upper end of the guide rail and where the guide rail is located in a pivoted position;

FIG. 5b a side cross-sectional view of the embodiment shown in FIG. 5a, with a guide rail in the position of use and a door inner trim prefitted on the module carrier and hung in the door ledge.

### DETAILED DESCRIPTION OF THE PREFERRED EMBODIMENTS

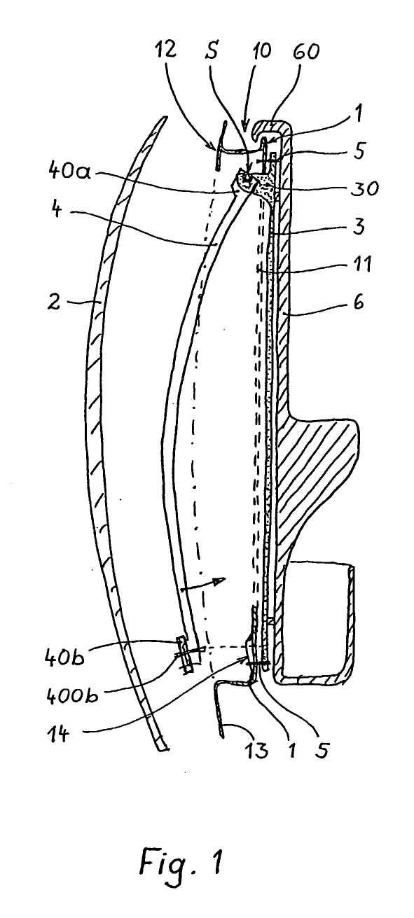

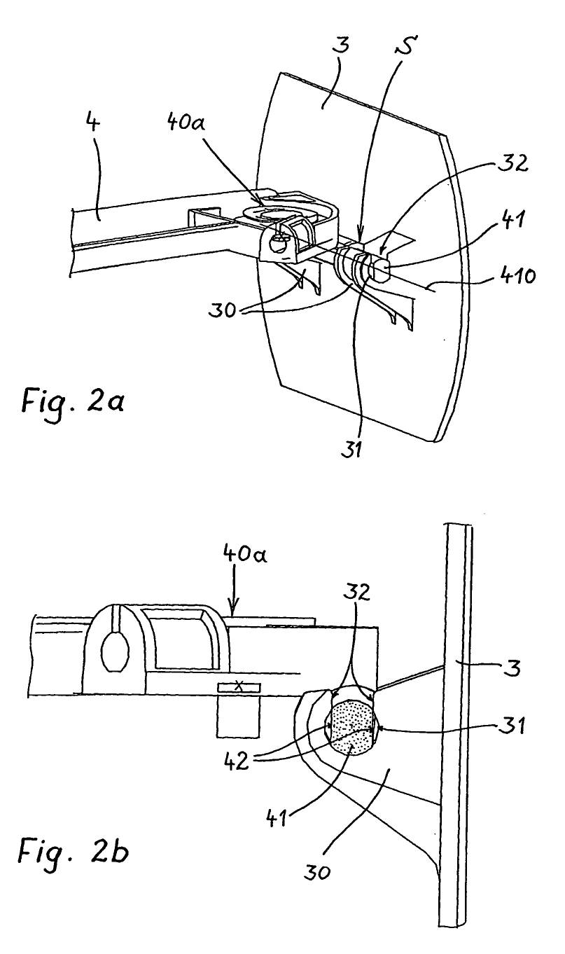

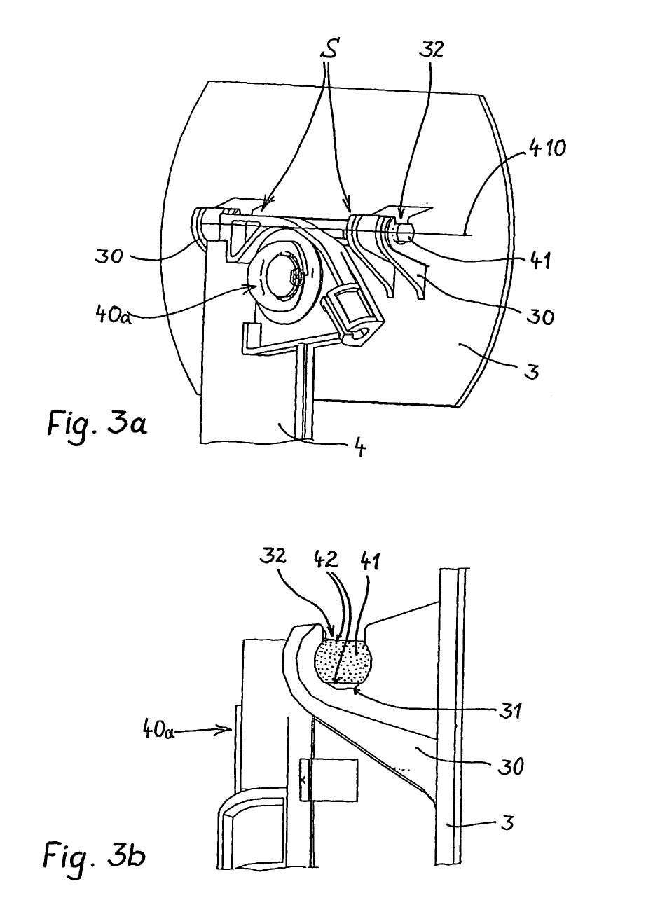

FIG. 1 shows a box-like body formed by a door inner skin 1 and which has in the region of the shaft opening 10 provided for the window pane, ledge areas which on one side serve for hanging the upper edge 60 of the door inner trim 6 and on the other hand for connecting (fixing area 12) the door outer skin 2. In the door inner skin 1 there is a large surface mounting opening 11 which is closed completely by the module carrier 3 so that an effective wet/dry space separation is produced. On the dry space side of the module carrier 3 the door inner trim is prefitted whilst on the wet space side the guide rail 4 of a cable window lifter is fixed in a pivotal bearing S whereby the length of the guide rail clearly exceeds the internal height of the assembly opening 11 in the door inner skin 1. The pivotal bearing S is an integral part of a bearing block 30 which is moulded on a module carrier 3 formed from plastics. In this embodiment the parts of the pivotal bearing S on the guide rail side which are a constituent part of a cable guide of plastics and will be explained in further detail in FIGS. 2a to 3b, form the upper closure of the window lifter system.

To fit the module system 3, 4, 6 it is supplied at an angle relative to the door plane to the door box formed from the door inner skin 1 so that first the hanging of the upper edge 60 of the door inner trim in the door ledge is possible. The guide rail 4 is then swivelled so far about the pivotal bearing S away from the module carrier 3 that it is possible to push the guide rail 4 through the assembly opening. The module carrier 3 can then be pivoted about the region of the mounting for the door inner trim 6 towards the door inner skin 1 and then through the fixing points 5 it is possible to fix the module carrier 3 on the door inner skin. Now the lower fixing area of the guide rail 4 is pushed onto the stop surface 14 on the wet space side of the door inner skin 1 and the fixing is completed. In this case the bearing axis 400b of the cable guide 40 at the same time forms the fixing means. The door assembly is then completed by connecting the door outer skin 2 to the fixing regions 12, 13 of the door inner skin.

From the front perspective view of FIG. 2a it is possible to see a cut-out section of a plastics module carrier 3 on whose wet space side two bearing blocks 30 with cylindrical bearing faces 31 are injection moulded which each have an upward pointing opening 32; wherein the internal width of the openings 32 is smaller than the diameter of the bearing faces 31. The associated snug fitting bearing bolt 41 is formed in one piece on a cable guide 40a which is made of plastics and the bearing bolt 41 has opposing parallel aligned flattened areas 42 whose spacing corresponds roughly to the internal width of the opening 32 (see also FIG. 2b). The flattened areas 42 are arranged so that the bearing bolt 41 can only be inserted into the bearing socket 31 through the opening 32 when the guide rail 4 is swivelled together with the cable guide 40a fixed thereon away from the module carrier 3 by a large angle. In the embodiment of FIGS. 2a and 2b the angle amounts to about 90 degrees.

FIGS. 3a and 3b show the guide rails 4 and the cable guides 40a in their position folded down into the position of use whereby the cylindrical bearing faces of the bearing block 30 and the bearing bolt 41 engage with each other and thus radially secure the position of the guide rail 4. In order to prevent displacement along the pivotal axis 410 the cable guide 40a is secured between the two bearing blocks 30.

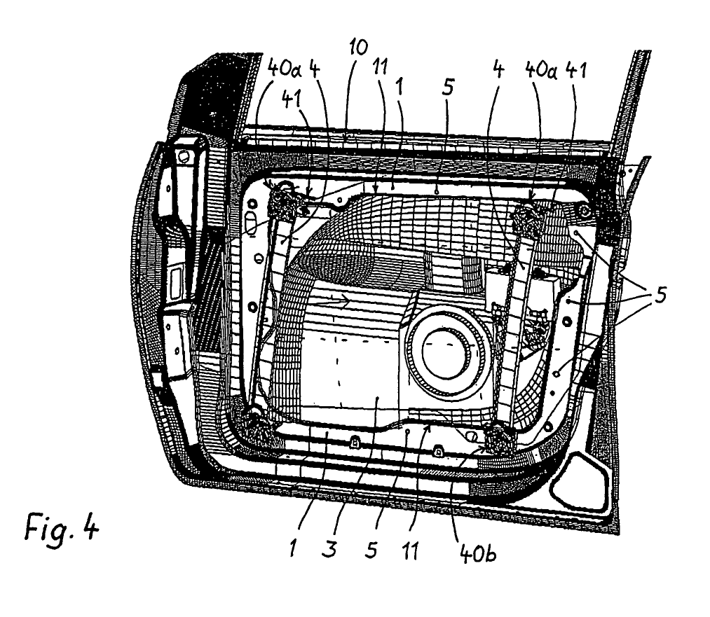

From the view of FIG. 4 it is possible to see the body formed by the door inner skin 1 from the wet space side. The large surface assembly opening 11 is completely covered by the module carrier 3 which is connected to the door inner skin 1 through fixing points 5. Directly underneath the upper edge of the assembly opening 11 are the pivotal bearings S″, 41 of the guide rails 4 which form in the upper region the single fastening means. In the lower region the guide rails 4 are connected through the cable guides 40b to the door inner skin 1 (see also here FIG. 1).

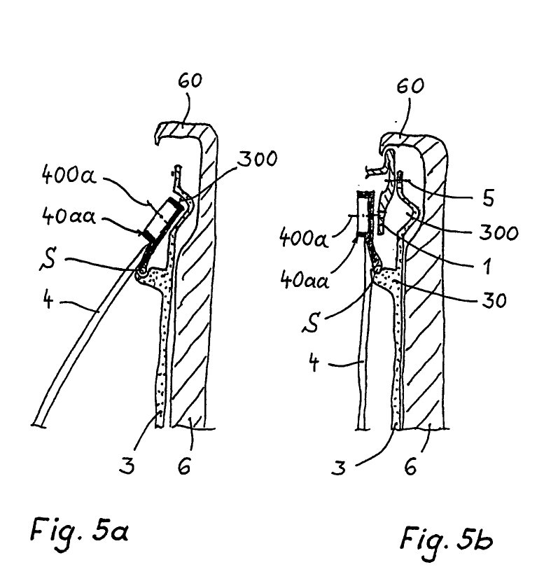

An alternative embodiment of the invention is seen in FIGS. 5a and 5b. Here the pivotal bearing S′—more particularly the pivotal axis—does not form the end-side closure of the guide rail 4, rather it is arranged removed therefrom so that a swivelling of the guide rail 4 would lead to collision of the cable guide 40aa with the module carrier 3. Therefore in the module carrier 3 there is a clearance 300, e.g. in the form of a bulge which enables the sufficient pivotal movement for fitting the module system.

According to the illustrated variation the parts of the pivotal bearing S″, on the rail side form with a plastics cable guide 40aa one structural unit which however only serves for prefitting. After the module system has reached its proposed position and the guide rail 4 has pivoted into its useful position the fixing of the guide rail 4 on the door inner skin 1 can take place through the axis 400a.

1. A motor vehicle door comprising:
a removable door outer skin;
a module carrier;
a door inner skin coupled on one side to the removable door outer skin and on its other side to the module carrier;
a door inner trim is fixed on a side of the module carrier facing a vehicle interior and on a side of the module carrier facing the door outer skin at least one guide rail of a cable window lifter is prefitted, wherein in one of an upper and lower region of the guide rail, a pivotal bearing is provided with a pivotal axis running substantially horizontal and parallel to the door plane for the purpose of prefitting the guide rail on the module carrier and at least a stop face proximate to the other of the upper and lower regions of the guide rail is associated with a side of the door inner skin which faces the door outer skin.

2. The motor vehicle door according to claim 1, wherein parts of the pivotal bearing proximate to the module carrier are integral constituent parts of the module carrier, and wherein the module carrier comprises plastics.

3. The motor vehicle door according to claim 1, wherein parts of the pivotal bearing proximate to the module carrier form a separate unit and are connected to the module carrier.

4. The motor vehicle door according to claim 1, wherein parts of the pivotal bearing proximate to the guide rail are integral constituent parts of one of the guide rail, and a cable guide connectable to the guide rail, and the one of the guide rail and cable guide comprises plastics.

5. The motor vehicle door according to at least one of the preceding claims, wherein the pivotal bearing forms on one side a cylindrical bearing socket which in relation to the pivotal axis has a radially aligned opening with a width which is reduced relative to a bearing bush diameter through which an associated bearing bolt with opposing flattened sides can be inserted, whereby the width of the bearing bolt between the flattened sides corresponds roughly to the width of the radially aligned opening of the bearing socket.

6. The motor vehicle door according to claim 5, wherein the radially aligned opening of the bearing socket points upwards and the flattened sides of the bearing bolt run transversely to the alignment of the opening when the guide rail is located in its useful a first position so that the guide rail can be fitted or dismantled from the pivotal bearing only when it is pivoted at an angle to the module carrier.

7. The motor vehicle door according to claim 1, wherein the pivotal bearing is the sole fixing point proximate to the pivotal bearing and the guide rail.

8. The motor vehicle door according to claim 1, wherein the pivotal bearing forms an end of one of a cable guide and the guide rail.

9. The motor vehicle door according to claim 1, wherein the pivotal bearing is spaced from an upper edge of one of a cable guide and the guide rail, wherein in the module carrier there is sufficient clearance so that when pivoting the guide rail about an angular region required for fitting the guide rail through an opening in the door inner skin, the end of one of the the guide rail at the pivotal bearing side and the corresponding cable guide is not stopped from pivoting against the module carrier.

10. The motor vehicle door according to claim 9, wherein the pivotal bearing serves mainly for prefitting and the one of the guide rail and the cable guide can be fixed in proximate to the pivotal bearing by means of a separate fixing element on the door inner skin.

11. The motor vehicle door according to claim 1, wherein a fixing axis of a fixing spot of the guide rail, which are not formed by the pivotal bearing, run through a cable guide.

12. The motor vehicle door according to claim 11, wherein the fixing axis is identical with a rotary axis of a cable guide pulley.

13. The motor vehicle door according to claim 1, wherein a transport securing device is provided which holds the guide rail in a defined position prior to fitting the module carrier.

14. The motor vehicle door according to claim 13, wherein the transport securing device is provided at a distance from the pivotal bearing.

15. The motor vehicle door according to claim 3, wherein the parts of the pivotal bearing proximate to the module carrier are connected to the module carrier through at least one of screws and rivets.

16. The motor vehicle door according to claim 6, wherein the flattened sides of the bearing bolt run orthogonal to the alignment of the opening when the guide rail is located in the first position.

17. The motor vehicle door according to claim 14, wherein the transport securing device is provided in a region of the other of the upper and lower regions of the guide rail.

18. The motor vehicle door according to claim 14, wherein the transport securing device is provided in the form of a clip-on connection.
